(19) United States
(12) Patent Application Publication
(10) Pub. No.: US 2009/0029089 A1
(43) Pub. Date: Jan. 29, 2009

(54) OPTICAL INFORMATION MEDIUM

(75) Inventors: Masaki AOSHIMA, Aichi (JP); Hiroyasu INOUE, Tokyo (JP); Syuji TSUKAMOTO, Tokyo (JP)

Correspondence Address: GREENBLUM & BERNSTEIN, P.L.C., 1950 ROLAND CLARKE PLACE, RESTON, VA, 20191, US

(73) Assignee: TDK Corporation, Tokyo (JP)

(21) Appl. No.: 12/178,100

(22) Filed: Jul. 23, 2008

(30) Foreign Application Priority Data
Jul. 24, 2007 (JP) 2007-191580

(51) Int. Cl. B32B 9/00

(52) U.S. Cl. 428/64.4

(57) ABSTRACT

An optical information medium includes a substrate and a recording layer formed on the substrate. The recording layer includes a first recording film formed of a first material that has Si as a main constituent and a second recording film that is formed of a second material that has Cu as a main constituent and to which Ni is added, the second recording film being formed in a periphery of the first recording film. Data is recorded onto and reproduced from the recording layer by irradiation of the recording layer with a laser beam.

### BACKGROUND OF THE INVENTION

1. Field of the Invention

The present invention relates to an optical information medium constructed so as to be capable of recording and reproducing data by irradiating a recording layer formed on a substrate with a laser beam.

2. Description of the Related Art

As one example of this type of optical information medium, an optical disc disclosed by Japanese Laid-Open Patent Publication No. S62-204442 is known. This optical disc is constructed by laminating a protective film, a recording layer and two protective films in that order on a substrate. Here, the recording layer is constructed by laminating a recording film (hereinafter, this recording film is referred to as the “first recording film”) formed of Si, Te, or the like and a recording film (hereinafter, this recording film is referred to as the “second recording film”) formed of Au, Ag, Ge, or the like. As one example, on an optical disc where the first recording film is formed of Si and the second recording film is formed of Au, when the recording layer is irradiated with a laser beam, the irradiated parts are melted and change to an AuSi alloy. In this case, information is recorded by changing the phase of the AuSi alloy to one of a crystallized state and an amorphous state according to the irradiation power and/or irradiation time of the laser beam.

On the other hand, to realize the recording and reproducing of a larger amount of data, a recording/reproducing apparatus that is equipped with an objective lens with a numerical aperture (NA) of 0.7 or higher (as one example, a numerical aperture of around 0.85) and carries out recording and reproducing by irradiating an optical information medium with a laser beam with a wavelength of 450 nm or below (as one example, a wavelength of around 405 nm) with a small spot diameter has been developed in recent years. In response to such research, the present inventors found that when the recording films described above that construct the recording layer are formed from Si and Cu, respectively, phase change will occur in the recording layer even when irradiated with a short-wavelength laser beam with a small spot diameter, and therefore the present inventors have already developed an optical information medium that is equipped with such recording layer and is capable of high-density recording.

### SUMMARY OF THE INVENTION

However, by investigating optical information media of this type that includes the optical disk described above, the present inventors found the following problem to be solved. For this type of optical information medium, as the recording capacity has increased due to increases in recording density, it has become necessary to record and reproduce data both at high speed and reliably. Here, to record data at high speed, it is necessary to stably irradiate a medium with a laser beam of a predetermined intensity. However, it is difficult to stabilize the output characteristics such as the rise speed (i.e., time to reach power required to record data), output value, and the like of the laser beam with the short wavelength described above compared to the output characteristics of a laser beam with a long wavelength (for example, a red laser beam). This means that when the environment in which the laser beam is irradiated is poor, when there is deterioration in the laser due to the laser reaching the end of its working life, or when the usage environment in which the optical information medium is used is poor, it will be rather difficult to record data (i.e., to cause phase change in the recording layer) and there is the risk that the original recording signal quality of the optical information medium will not be attained. Accordingly, there is demand for the development of an optical information medium that can reliably record data even in a state where the output characteristics of the laser beam (i.e., the optical characteristics of the incoming light at the recording film surface) are somewhat unstable.

The present invention was conceived in view of the problem described above and it is a principal object of the present invention to provide an optical information medium that can reliably record data even in a state where the output characteristics of a laser beam are unstable.

To achieve the stated object, an optical information medium according to the present invention includes: a substrate; and a recording layer formed on the substrate, the recording layer including a first recording film formed of a first material that has Si as a main constituent and a second recording film that is formed of a second material that has Cu as a main constituent and to which Ni is added, the second recording film being formed in a periphery of the first recording film, wherein data is recorded onto and reproduced from the recording layer by irradiation of the recording layer with a laser beam.

According to this optical information medium, by forming the first recording film of the first material that has Si as a main constituent and the second recording film that is formed of a second material that has Cu as a main constituent and to which Ni is added, the second recording film being formed in a periphery of the first recording film, due to the added Ni, it is possible to make it easier for the materials to mix when irradiated with the laser beam and to increase the range of power (that is, the tolerated range of fluctuation of the power) of the laser beam where the recording parts (that is, parts formed by both materials mixing due to irradiation with the laser beam) can be reliably formed in a favorable state. This means that even if the power of the laser beam somewhat fluctuates, it will still be possible to reliably form the recording parts in a favorable state, or in other words to reliably record data in a favorable state. Therefore, according to this optical information medium, it will be possible to stably record data even when a laser beam of a short wavelength, for which it is comparatively difficult to stabilize the output characteristics such as the rise speed, output value, and the like, is used.

Here, Ni may be added in a range of at least 0.7 at % to less than 44.0 at % to the second material. By doing so, it is possible to achieve sufficient reproduction durability while achieving a sufficiently wide range for the power of the laser beam that can reliably form the recording parts in a favorable state.

Also, the recording layer may be constructed with the first recording film and the second recording film in contact. By using this construction, it is possible to make it even easier for the first material and the second material to mix when the recording layer is irradiated with a laser beam adjusted to the recording power.

Also, a protective layer may be formed on the recording layer. By doing so, it is possible to reliably prevent damage to the recording layer and the like.

In addition, the protective layer may be formed so as to be capable of transmitting the laser beam, the recording layer may be constructed by forming the second recording film and the first recording film in the mentioned order on the substrate, and data may be recorded and reproduced by irradiation of the recording layer with the laser beam from the protective layer side. By using this construction, since the protective layer can be formed thinner than the substrate, it is possible to achieve a sufficient tilt margin, even when a pickup equipped with an objective lens with a large numerical aperture is used. Since the second recording film with a high reflectivity for light is positioned on the side of the recording layer that is deep inside the optical information medium in the direction in which the laser beam is incident, compared to when the recording layer is constructed by forming the first recording film and the second recording film in the mentioned order on the substrate, it is possible to form the recording parts with a laser beam with a lower power.

The optical information medium may further include a first dielectric layer formed between the recording layer and the protective layer and a second dielectric layer formed between the substrate and the recording layer. By using this construction, it is possible to avoid thermal deformation of the substrate or the protective layer when the laser beam is incident (i.e., when the recording parts are formed). As a result, it is possible to reliably avoid a situation where the noise level increases due to such thermal deformation. Also, since it is possible to avoid corrosion of the recording layer, it is possible to maintain a state where data can be properly reproduced over a long term.

The optical information medium may further include a reflective layer formed between the substrate and the second dielectric layer. By using this construction, the second dielectric layer and the reflective layer act in concert to significantly increase the multiple interference effect and significantly increase the difference in light reflectivity between the recording parts and unrecorded parts, which makes it possible to reproduce data more reliably.

It should be noted that the disclosure of the present invention relates to a content of Japanese Patent Application 2007-191580 that was filed on 24 Jul. 2007 and the entire content of which is herein incorporated by reference.

### BRIEF DESCRIPTION OF THE DRAWINGS

These and other objects and features of the present invention will be explained in more detail below with reference to the attached drawings, wherein:

FIG. 1 is a cross-sectional view showing the construction of an optical information medium;

FIG. 2 is a graph useful in explaining the relationship between best power and jitter (“power margin”);

FIG. 3 is a table showing the relationship between the amount of Ni added to the second recording film material, the power margin, and the best power;

FIG. 4 is a graph showing the relationship between the amount of Ni added to the second recording film material, the power margin, and the best power;

FIG. 5 is a table showing the relationship between the amount of Ni added to the second recording film material and the jitter before and after reproduction; and

FIG. 6 is a graph showing the relationship between the amount of Ni added to the second recording film material and the jitter before and after reproduction.

### DESCRIPTION OF THE PREFERRED EMBODIMENTS

Preferred embodiments of an optical information medium according to the present invention will now be described with reference to the attached drawings.

First, the construction of an optical information medium 1 will be described with reference to the drawings.

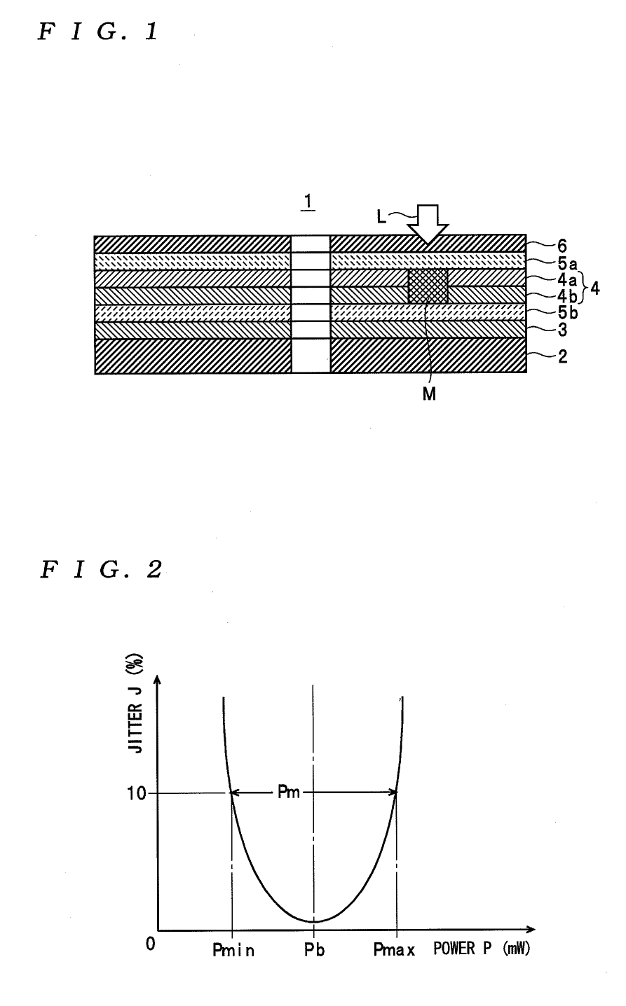

The optical information medium 1 is a single-sided, single-layer optical information medium that is formed in a disc shape with an external diameter of around 120 mm and a thickness of around 1.2 mm, and is constructed so as to be capable of recording and reproducing data using a blue-violet laser beam L (hereinafter referred to simply as the “laser beam L”) with a wavelength in a range of 380 nm to 450 nm inclusive (as one example, 405 nm) that is emitted from an objective lens with a numerical aperture of 0.7 or higher (as one example, around 0.85). More specifically, as shown in FIG. 1, the optical information medium 1 is constructed by laminating a reflective layer 3, a second dielectric layer 5b, a recording layer 4, a first dielectric layer 5a, and a light transmitting layer 6 in the mentioned order on a substrate 2. An attachment center hole for attachment (clamping) to a recording/reproducing apparatus is formed in the center of the optical information medium 1.

The substrate 2 is formed in a disc shape with a thickness of around 1.1 mm by injection molding polycarbonate resin, for example. The substrate 2 can alternatively be formed by various other methods, such as by using a photopolymer (“2P”). On one surface of the substrate 2 (the upper surface in FIG. 1), grooves and lands are formed in a spiral from the center toward the outer edge. The grooves and lands function as guide tracks when recording and reproducing data on the recording layer 4. Accordingly to make proper tracking possible, as one example, the grooves should preferably be formed between the lands with a depth in a range of 10 nm to 40 nm, inclusive, and a pitch in a range of 0.2 μm to 0.4 μm, inclusive. In addition, the optical information medium 1 is constructed with a premise of the laser beam L being emitted from the light transmitting layer 6 side during recording and reproducing. Since the substrate 2 does not need to transmit light, there is an increase in the number of materials that can be selected to form the substrate 2 compared to a typical existing optical information medium (for example, a CD-R). More specifically, the material for forming the substrate 2 is not limited to the polycarbonate resin mentioned above and it is possible to use various resin materials (such as olefin resin, acrylic resin, epoxy resin, polystyrene resin, polyethylene resin, polypropylene resin, silicone resin, fluorine resin, ABS resin, and urethane resin), or other materials such as glass and ceramics. However, it is preferable to use a resin material such as polycarbonate resin or olefin resin since resin is easy to mold and comparatively inexpensive.

The reflective layer 3 is provided to reflect the laser beam L emitted from the light transmitting layer 6 side during the reproduction of data and is formed with a thickness in a range of 10 nm to 300 nm inclusive of a metal material such as Mg, Al, Ti, Cr, Fe, Co, Ni, Cu, Zn, Ge, Ag, Pt, or Au or an alloy of such metals (as examples, AgNdCu=98:1:1 or AgPdCu=98:1:1). In this case, to achieve a required and sufficient reflectivity for the laser beam L, the thickness of the reflective layer 3 should preferably be set in a range of 20 nm to 200 nm, inclusive (as one example, 100 nm). Regarding the material that forms the reflective layer 3, since a metal such as Al, Au, Ag, or Cu or a metal material such as an alloy of Ag and Cu has a high reflectivity, it is preferable to use a metal material including at least one of such metals.

The first dielectric layer 5a and the second dielectric layer 5b (hereinafter referred to as the “dielectric layers 5” when no distinction is required) respectively correspond to a “first dielectric layer” and a “second dielectric layer” for the present invention, and are formed so as to sandwich the recording layer 4. The dielectric layers 5 prevent corrosion of the recording layer 4, that is, deterioration in the data and also prevent thermal deformation of the substrate 2 and the light transmitting layer 6 during the recording of data, which makes it possible to avoid increases in jitter J. The second dielectric layer 5b also functions so as to increase the change in optical characteristics between recording parts (parts where pits are formed in the recording layer) and unrecorded parts (parts where pits have not been formed) due to a multiple interference effect. To enhance the change in optical characteristics, it is preferable to form the second dielectric layer 5b of a dielectric material with a high refractive index for the wavelength range of the laser beam L. When the laser beam L is emitted, if an excessive amount of energy is absorbed by the dielectric layers 5, there will be a drop in the recording sensitivity of the recording layer 4. It is preferable to avoid such a drop in recording sensitivity by constructing the dielectric layers 5 of a dielectric material with a low extinction coefficient for the wavelength range of the laser beam L.

More specifically, as the dielectric material used to form the dielectric layers 5, to prevent thermal deformation of the substrate 2, the light transmitting layer 6, and the like and obtain favorable protection characteristics for the recording layer 4 while achieving a sufficient multiple interference effect, it is preferable to use a light-transmitting dielectric material that is one or a mixture of Al₂O₃, AlN, ZnO, ZnS, GeN, GeCrN, CeO₂, SiO, SiO₂, Si₃N₄, SiC, La₂O₃, TaO, TiO₂, SiAlON (a mixture of SiO₂, Al₂O₃, Si₃N₄ and AlN), and LaSiON (a mixture of La₂O₃, SiO₂, and Si₃N₄), or an oxide, nitride, sulfide, or carbide of Al, Si, Ce, Ti, Zn, Ta, or the like. Here, it is possible to form the first dielectric layer 5a and the second dielectric layer 5b from the same dielectric material or from different dielectric materials. Also, one or both of the first dielectric layer 5a and the second dielectric layer 5b may have a multilayer structure composed of a plurality of dielectric layers.

In this optical information medium 1, the first dielectric layer 5a and the second dielectric layer 5b are formed with a thickness in a range of 10 nm to 200 nm, inclusive (as one example, 25 nm) from a dielectric material that has a mixture of ZnS and SiO₂ (preferably with a mole ratio of 80:20) as a main constituent. Here, since a mixture of ZnS and SiO₂ has a high refractive index and a comparatively low extinction coefficient for a laser beam L with a wavelength in a range of 380 nm to 450 nm, inclusive, it is possible to make the changes in the optical characteristics of the recording layer 4 before and after the recording of data more prominent, and to avoid a drop in the recording sensitivity. The respective thicknesses of the first dielectric layer 5a and the second dielectric layer 5b are not limited to the example described above, but when the thicknesses are below 10 nm, it is difficult to achieve the effects described above. On the other hand, when the dielectric layers 5 are over 200 nm thick, the time required to form the layers will increase, resulting in the risk of an increase in the manufacturing cost of the optical information medium 1 and also the risk of cracks appearing in the optical information medium 1 due to internal stresses in the first dielectric layer 5a and/or the second dielectric layer 5b. Accordingly, the thicknesses of both dielectric layers 5a, 5b should preferably be set in a range of 10 nm to 200 nm, inclusive. The recording layer 4 is a layer in which recording parts M (pits) are formed due to the optical characteristics of the recording layer 4 changing (here, a phase change) when the laser beam L is emitted during the recording of data. The recording layer 4 is constructed by forming two thin films, i.e., a second sub-recording film 4b and a first sub-recording film 4a, in the mentioned order on the second dielectric layer 5b. By constructing the recording layer 4 of the first sub-recording film 4a and the second sub-recording film 4b in the mentioned order from the light transmitting layer 6 side (i.e., from the side on which the laser beam L is incident), it becomes possible for the optical characteristics of the recording layer 4 to sufficiently change even when the laser beam L has comparatively low power P, which means that the recording parts M can be reliably formed. The first sub-recording film 4a corresponds to a “first recording film” for the present invention and is formed in a thin film shape of a material with Si as a main constituent (this material corresponds to a “first material” for the present invention and is referred to below as the “first recording film material”). Here, on the optical information medium 1, the ratio of the Si included in the entire material of the first sub-recording film 4a is set at at least 95 at % (as one example, at 99 at %).

The second sub-recording film 4b corresponds to a “second recording film” for the present invention and is formed in a thin film shape of a material where Cu is the main constituent and to which Ni is added (this material corresponds to a “second material” for the present invention and is referred to below as the “second recording film material”). Here, it is clear from the results of experiments conducted by the present inventors that when the second sub-recording film 4b is formed of a material where Cu is the main constituent and to which Ni is added, it becomes easier for the first recording film material and the second recording film material to mix when irradiated with the laser beam L during the recording of data. It is also clear from the results of experiments conducted by the present inventors that there is an increase in the range of the power P of the laser beam L that can reliably form recording parts M in a favorable state (that is, a state with low jitter) or in other words, there is an increase in the tolerated range of fluctuation of the power P where the recording parts M can still be reliably formed in a favorable state (hereinafter, an index showing the range of the power P is referred to as the “power margin Pm”, and the method of calculation thereof is described later).

In this case, to achieve a sufficient power margin Pm, the amount of Ni added to the second recording film material should preferably be at least 0.7 at % and more preferably at least 2.2 at %. On the other hand, since it becomes easier for both recording film materials to mix as the added amount of Ni increases, when the added amount is excessive, there is the risk of both recording film materials mixing when a laser beam L with a low power P used for reproduction is irradiated, which would lower the storage characteristics (“reproduction durability”) of the recording parts M. Accordingly, to achieve a sufficient reproduction durability, the amount of Ni added to the second recording film material should preferably be suppressed to less than 44.0 at % and more preferably to 15.4 at % or below. That is, to achieve both a sufficient power margin Pm and sufficient reproduction durability, the added amount of Ni should preferably be set in a range of at least 0.7 at % to less than 44.0 at % or more preferably in a range of 2.2 at % to 15.4 at %, inclusive. Here, the greater the thickness of the first sub-recording film 4a and the thickness of the second sub-recording film 4b (i.e., the total thickness of the recording layer 4), the larger the drop in the surface smoothness of the first sub-recording film 4a that is closer to the surface on which the laser beam L is incident, the higher the noise level in a reproduction signal, and the lower the recording sensitivity. When the total thickness of the recording layer 4 exceeds 50 nm, there is a drop in recording sensitivity, which leads to the risk that the medium will be unusable as an optical information medium. On the other hand, when the total thickness of the recording layer 4 is excessively thin, there is a reduction in the amount of change in the optical characteristics before and after the recording of data and a fall in the C/N ratio, which results in difficulty in reproducing data properly. Accordingly, to avoid such problems, the total thickness of the recording layer 4 should preferably be set in a range of 2 nm to 50 nm, inclusive, and more preferably in a range of 2 nm to 30 nm, inclusive. In addition, to achieve both a reduction in the noise level included in the reproduction signal and a reduction in the deterioration over time in the noise level, the sub-recording films 4a and 4b should preferably be formed so that the total thickness of the recording layer 4 is in a range of 5 nm to 15 nm, inclusive.

Although the respective thicknesses of both sub-recording films 4a and 4b are subject to no particular limitations, the respective thicknesses should preferably be set in a range of 2 nm to 30 nm, inclusive so that there is a sufficient improvement in recording sensitivity and a sufficient change in the optical characteristics before and after the recording of data. Also, to cause an even greater change in the optical characteristics before and after the recording of data, the respective thicknesses should preferably be set so that the ratio between the thickness of the first sub-recording film 4a and the thickness of the second sub-recording film 4b (that is, the thickness of the first sub-recording film 4a/the thickness of the second sub-recording film 4b) is in a range of 0.2 to 5.0, inclusive. Here, on the optical information medium 1, as one example, by setting the thickness of the first sub-recording film 4a at 5 nm and the thickness of the second sub-recording film 4b at 5 nm, the recording layer 4 is formed so that the overall thickness becomes 10 nm.

The light transmitting layer 6 corresponds to a “protective layer” according to the present invention, is a layer that functions as an optical path of the laser beam L during the recording and reproducing of data and physically protects the recording layer 4, the first dielectric layer 5a, and the like, and is formed of a resin material such as a UV curable resin or an electron beam curable resin with a thickness in a range of 1 μm to 200 μm, inclusive (preferably in a range of 50 μm to 150 μm, inclusive: as one example, 100 μm). In this case, when the thickness of the light transmitting layer 6 is below 1 μm, it is difficult to protect the recording layer 4, the first dielectric layer 5a, and the like, while when the thickness of the light transmitting layer 6 exceeds 200 μm, it is difficult to form a light transmitting layer 6 with a uniform thickness (in particular, the thickness in the radial direction). Also, when different materials are used for the substrate 2 and the light transmitting layer 6 and as one example the light transmitting layer 6 is formed as a thicker layer than the substrate 2, there are cases where warping of the optical information medium 1 will occur due to thermal expansion, thermal contraction, or the like. Note that a number of methods can be used as the method of forming the light transmitting layer 6, such as a method that applies a resin material by spin coating or the like and then cures the resin material and a method that sticks a sheet formed of light-transmitting resin onto the first dielectric layer 5a using adhesive or the like. However, to avoid attenuation of the laser beam L, spin coating should preferably be used since no layer of adhesive is formed.

Next, a method of manufacturing the optical information medium 1 will be described with reference to the drawings.

When manufacturing the optical information medium 1, first, the substrate 2 is injection molded using a polycarbonate resin. Here, spiral grooves and lands are formed on one surface of the substrate 2 during injection molding using a stamper. Next, the reflective layer 3 is formed with a thickness of around 100 nm on the surface of the substrate 2 by vapor-phase deposition (such as vacuum evaporation or sputtering, in this example sputtering) using a chemical species with Ag as a main constituent, for example. After this, the second dielectric layer 5b is formed with a thickness of around 25 nm so as to cover the reflective layer 3 by vapor-phase deposition using a chemical species with a mixture of ZnS and SiO₂ as a main constituent. Next, the second sub-recording film 4b is formed with a thickness of around 5 nm so as to cover the second dielectric layer 5b by vapor-phase deposition using a material (chemical species) that has Cu as a main constituent and to which Ni has been added.

The first sub-recording film 4a is then formed with a thickness of around 5 nm so as to cover the second sub-recording film 4b by vapor-phase deposition using a material (chemical species) that has Si as a main constituent. After this, the first dielectric layer 5a is formed with a thickness of around 25 nm so as to cover the first sub-recording film 4a by vapor-phase deposition using a chemical species with a mixture of ZnS and SiO₂ as a main constituent. Note that the reflective layer 3, the second dielectric layer 5b, the second sub-recording film 4b, the first sub-recording film 4a, and the first dielectric layer 5a should preferably be consecutively formed on the substrate 2 by appropriately adjusting deposition conditions in each chamber of a sputtering machine with a plurality of sputtering chambers. After this, by applying an acrylic UV-curable resin (or an epoxy UV-curable resin), for example, by spin coating so as to cover the first dielectric layer 5a and curing the resin, the light transmitting layer 6 is formed with a thickness of around 100 μm on the first dielectric layer 5a. Here, to form the light transmitting layer 6 with a uniform thickness (in particular, a uniform thickness in the radial direction), various conditions during spin coating (such as the rotational velocity, the rate of change of such velocity, and time until rotation is stopped) are adjusted as appropriate. To form the light transmitting layer 6 with a thickness of around 100 μm, it is preferable to use a resin material with fairly high viscosity (in this case, a UV-curable resin). By doing so, the optical information medium 1 is completed.

The principles behind the recording of data on the optical information medium 1 will now be described with reference to the drawings.

First, the laser beam L with a wavelength of 405 nm and a power adjusted to a recording power P (as one example, a power P of around 5.0 mW at the surface of the recording layer 4) is emitted via an objective lens with a numerical aperture of 0.85 onto the optical information medium 1. When doing so, in the recording layer 4, the first recording film material that constructs the first sub-recording film 4a and the second recording film material that constructs the second sub-recording film 4b become mixed at the parts irradiated with the laser beam L to form the recording parts M as shown in FIG. 1. Note that although FIG. 1 shows a state where a recording part M is formed at a region irradiated with the laser beam L due to the mixing of the first sub-recording film 4a and the second sub-recording film 4b across the entire range in the thickness direction, even if only parts of the first sub-recording film 4a and the second sub-recording film 4b become mixed at the boundary of the first sub-recording film 4a and the second sub-recording film 4b, recording parts M that allow data to be properly reproduced (i.e., recording parts M that can be sufficiently read) will still be formed. Here, there is a large difference in optical characteristics between the parts where the first sub-recording film 4a and the second sub-recording film 4b are laminated (hereinafter, “laminated parts”) and the recording parts M. This means a large difference is produced between the reflectivity when the laminated parts are irradiated with a laser beam L that has been adjusted to a reproduction power P and the reflectivity when the recording parts M are irradiated. Accordingly, by detecting such difference, it is possible to identify the presence of the recording parts M (pits) and thereby reproduce (read) the data using a recording/reproducing apparatus.

Here, in the optical information medium 1, by forming the second sub-recording film 4b of a material with Cu as a main constituent and Ni added, compared to a case where the second sub-recording film 4b is made of material to which Ni is not added, it is easier for the first recording film material and the second recording film material to mix when irradiated with the laser beam L. As a result, the range of the power P of the laser beam L that can reliably form the recording parts M in a favorable state, that is, the tolerated range of fluctuation of the power P for reliably forming the recording parts M in a favorable state is increased. This means that even if the power P of the laser beam L somewhat fluctuates, for example, it will still be possible to reliably form the recording parts M (i.e., to reliably record the data). Accordingly, with the optical information medium 1, even if a laser beam L with a short wavelength where it is comparatively difficult to stabilize the output characteristics such as the rise speed, output value, and the like is used, it will still be possible to realize the stable recording of data. Also, on the optical information medium 1, the second sub-recording film 4b and the first sub-recording film 4a are formed in the mentioned order on the substrate 2. Accordingly, since the second sub-recording film 4b formed of the second recording film material that has Cu, which has a high reflectivity for light, as a main constituent is positioned deep inside the optical information medium 1 in the direction in which the laser beam L is incident, compared to a construction where the first sub-recording film 4a and the second sub-recording film 4b are formed in the mentioned order on the substrate 2, it is possible to reliably form the recording parts M in the recording layer 4 even with a laser beam L with a low power P.

Also, since the recording layer 4 is sandwiched by the first dielectric layer 5a and the second dielectric layer 5b, even if the first sub-recording film 4a and the second sub-recording film 4b are heated by irradiation with the laser beam L to an extent where the films become mixed, thermal deformation of the substrate 2 and the light transmitting layer 6 is avoided. By doing so, a rise in the noise level, a drop in the C/N ratio, and increased jitter J are all avoided. In addition, since the first sub-recording film 4a is formed of a first recording film material with Si as a main constituent and the second sub-recording film 4b is formed of a second recording film material with Cu as a main constituent, there is a sufficient change in the optical characteristics before and after the recording of the recording parts M. As a result, the presence of the recording parts M is reliably detected and data is reliably reproduced.

Note that the present inventors conducted two types of experiments (hereinafter referred to as “first experiments” and “second experiments”) described below to verify the effect of adding Ni to the second recording film material used to form the second sub-recording film 4b. In the first experiments, five types of first sample optical information media 1 with different amounts of added Ni were manufactured according to the method of manufacturing described above (hereinafter the first sample optical information media are referred to as the “optical information media 1a to 1e”). The respective added amounts of Ni in the second recording film materials for forming the second sub-recording films 4b of the optical information media 1a to 1e were set at 0.7 at %, 2.2 at %, 3.6 at %, 7.2 at %, and 15.4 at %. Also, as a comparative example, an optical information medium equipped with a second sub-recording film 4b formed using a recording film material to which Ni is not added (i.e., where the added amount is 0 at %) was also manufactured (hereinafter, this optical information medium is referred to as the “comparison optical information medium 1f”). Next, test data was recorded on the respective optical information media 1a to 1f by irradiation with a laser beam L with a wavelength of 405 nm via an objective lens with a numerical aperture of 0.85 and jitter J was measured based on the form and the like of the recording parts M formed in the recording layer 4 by recording the test data. When doing so, the power P of the laser beam L was varied, the jitter J at each power P was measured, and as shown in FIG. 2, a graph showing the relationship between the power P and the jitter J was generated.

Next, the power P of the laser beam L where the jitter J is minimized (that is, where the recorded state is most favorable) was specified based on the generated graph (hereinafter, such power P is referred to as the “best power Pb”: see FIG. 2). Also, based on this graph, the power margin Pm is specified as an index showing the range of the power P of the laser beam L where the recording parts M can be reliably formed in a favorable state, that is, the tolerated range of fluctuation of the power P for reliably forming the recording parts M in a favorable state. Here, as shown in FIG. 2, the power margin Pm is calculated according to Equation (1) below with the largest power P for which the value of jitter J is a predetermined value (as one example, 10%) as “Pmax” and the lowest power P as “Pmin”.

Pm(%)=((Pmax−Pmin)/Pb)×100 Equation (1)

Also, for the second experiments, five types of second sample optical information media 1 with different amounts of added Ni were manufactured according to the method of manufacturing described above (hereinafter, these second sample optical information media are referred to as the “optical information media 1g to 1k”). The respective added amounts of Ni in the second recording film materials for forming the second sub-recording films 4b of the respective optical information media 1g to 1k were set at 0.7 at %, 2.2 at %, 15.4 at %, 38.5 at %, and 44.0 at %. Also, as a comparative example, the comparison optical information medium 1f described above was used. Next, test data was recorded on the respective optical information media 1f to 1k by irradiation with a laser beam L with a wavelength of 405 nm via an objective lens with a numerical aperture of 0.85. Here, the power P of the laser beam L was set at the respective best powers Pb for the optical information media 1f to 1k. After this, jitter J was measured based on the form and the like of the recording parts M formed in the recording layer 4 by recording the test data. Next, the respective optical information media 1f to 1k were irradiated with a reproduction laser beam L (as one example, a laser beam L with a wavelength of 405 nm and a power P of around 1 mW) to repeatedly reproduce the test data one million times, and the jitter J was then measured again. After this, the ratio (multiple) Rj of the jitter J after reproduction to the jitter J before reproduction was calculated and the reproduction durability was evaluated based on the ratio Rj.

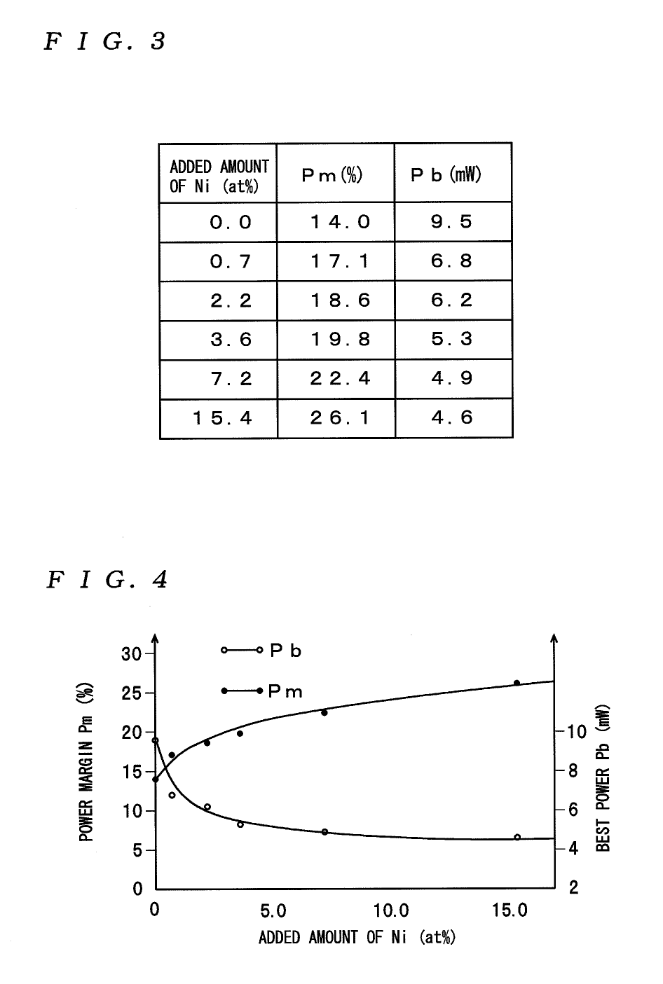

From the first experiment results described above, as shown in FIGS. 3 and 4, it is clear that when Ni is added to the second recording film material, the best power Pb falls, that is, it becomes easy for the first recording film material that constructs the sub-recording film 4a and the second recording film material that constructs the sub-recording film 4b to mix. It is also clear that as the added amount of Ni increases, there is a gradual fall in the best power Pb (i.e., there is an increase in the ease with which the recording film materials can mix). In addition, as shown in FIG. 3 and FIG. 4, it is clear that by adding Ni to the second recording film material, the power margin Pm is increased, or in other words, the range of power P that can reliably form the recording parts M in a favorable state is increased. It is also clear that the power margin Pm increases (i.e., the range of the power P described above becomes wider) in proportion to the increase in the added amount of Ni. Here, it is clear that when the added amount of Ni is 0.7 at %, there is an enough increase in the power margin Pm to over 17%. It is also clear that when the added amount of Ni is 2.2 at %, there is a greater increase in the power margin Pm to over 18%.

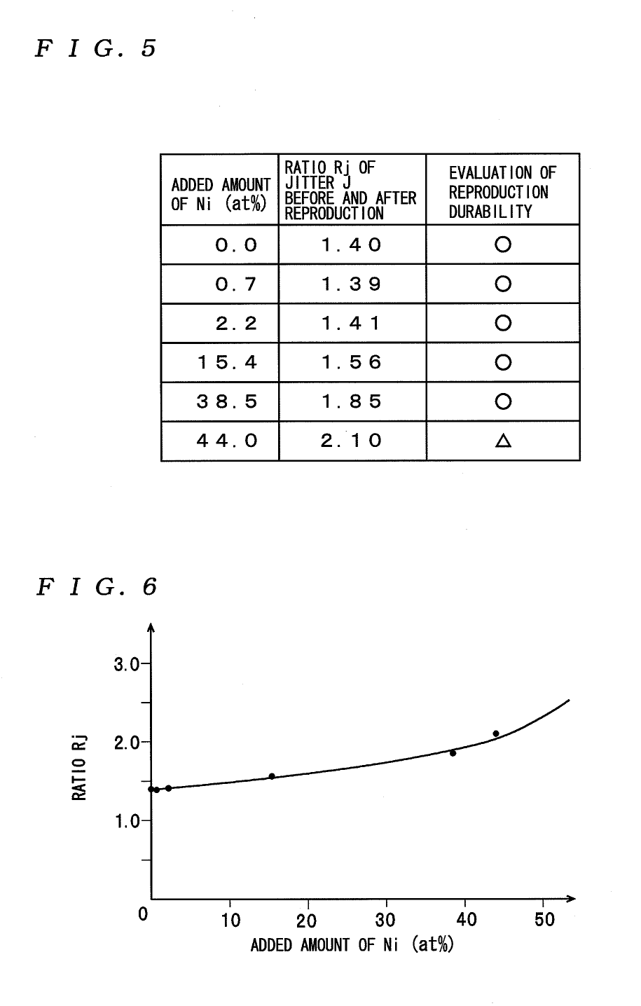

From the second experiment results, as shown in FIGS. 5 and 6, it is clear that the ease of mixing of the recording film materials increases and the ratio Rj described above increases, that is, the reproduction durability falls, as the added amount of Ni increases. In this case, since the ratio Rj exceeds 2 when the added amount of Ni is 44.0 at %, there is the risk that reproduction problems will occur after reproduction has been carried out repeatedly. Accordingly, it is clear that to achieve sufficient reproduction durability, it is preferable to suppress the amount of Ni added to the second recording film material to less than 44.0 at %. It is also clear that to suppress the ratio Rj to below 1.6 and achieve significantly higher reproduction durability, it is preferable to suppress the added amount of Ni added to the second recording film material to 15.4 at % or below.

In this way, according to the optical information medium 1, by forming the first sub-recording film 4a using the first recording film material that has Si as a main constituent and forming the second sub-recording film 4b using the second recording film material that has Cu as a main constituent and to which Ni is added in the periphery of the first sub-recording film 4a, due to the added Ni, it is possible to make it easier for both recording film materials to mix when irradiated with the laser beam L and to increase the range of the power P (that is, the tolerated range of fluctuation of the power P) of the laser beam L where the recording parts M can be reliably formed in a favorable state. This means that even if the power P of the laser beam L somewhat fluctuates, it will still be possible to reliably form the recording parts M in a favorable state, or in other words to reliably record data in a favorable state. Therefore, according to the optical information medium 1, it will be possible to stably record data even when a laser beam L of a short wavelength, for which it is comparatively difficult to stabilize the output characteristics such as the rise speed, output value, and the like, is used.

According to the optical information medium 1, by forming the second sub-recording film 4b using the second recording film material to which Ni has been added in a range from at least 0.7 at % to less than 44.0 at %, it is possible to achieve sufficient reproduction durability while achieving a sufficiently wide range for the power P of the laser beam L that can reliably form the recording parts M in a favorable state.

Also, according to the optical information medium 1, by constructing the recording layer 4 so that the first sub-recording film 4a and the second sub-recording film 4b as in contact, it is possible to make it even easier for the first recording film material and the second recording film material to mix when the recording layer 4 is irradiated with a laser beam L adjusted to the recording power P.

In addition, according to the optical information medium 1, by forming the light transmitting layer 6 on the recording layer 4, it is possible to reliably prevent damage to the first dielectric layer 5a, the recording layer 4, and the like.

Also according to the optical information medium 1, by constructing the recording layer 4 by forming the second sub-recording film 4b and the first sub-recording film 4a in the mentioned order on the substrate 2 and using a construction where data is recorded and reproduced by irradiating the recording layer 4 with a laser beam L from the light transmitting layer 6 side, since the light transmitting layer 6 can be formed thinner than the substrate 2, it is possible to achieve a sufficient tilt margin, even when a pickup equipped with an objective lens with a large numerical aperture (NA) is used. Since the second sub-recording film 4b with a high reflectivity for light is positioned on the side of the recording layer 4 that is deep inside the optical information medium 1 in the direction in which the laser beam L is incident, compared to when the recording layer 4 is constructed by forming the first sub-recording film 4a and the second sub-recording film 4b in the mentioned order on the substrate 2, it is possible to form the recording parts M with a laser beam L with a lower power P.

Also, according to the optical information medium 1, by forming the first dielectric layer 5a between the recording layer 4 and the light transmitting layer 6 and forming the second dielectric layer 5b between the substrate 2 and the recording layer 4, it is possible to avoid thermal deformation of the substrate 2 or the light transmitting layer 6 when the laser beam L is incident (i.e., when the recording parts M are formed). As a result, it is possible to reliably avoid a situation where the noise level increases due to such thermal deformation. Also, since it is possible to avoid corrosion of the recording layer 4, it is possible to maintain a state where data can be properly reproduced over a long term.

According to the optical information medium 1, by forming the reflective layer 3 between the substrate 2 and the second dielectric layer 5b, the second dielectric layer 5b and the reflective layer 3 act in concert to significantly increase the multiple interference effect and significantly increase the difference in light reflectivity between the recording parts M and unrecorded parts, which makes it possible to reproduce data more reliably.

Note that the present invention is not limited to the construction described above. For example, although an example has been described where the present invention is applied to the optical information medium 1 where the reflective layer 3, the second dielectric layer 5b, the recording layer 4, the first dielectric layer 5a, and the light transmitting layer 6 are laminated in the mentioned order on the substrate 2, it is also possible to apply the present invention to an optical information medium constructed so that the first dielectric layer 5a, the recording layer 4, the second dielectric layer 5b, the reflective layer 3, and the light transmitting layer (protective layer) 6 are laminated in the mentioned order on the substrate 2 so that data can be recorded and reproduced by irradiation with the laser beam L from the substrate 2 side. Also, although an example where the present invention is applied to the single-sided, single-layer optical information medium 1 where one recording layer 4 is formed on one surface of the substrate 2 has been described, it is also possible to apply the present invention to a single-sided, multi-layer (for example, single-sided, two-layer) optical information medium with a plurality of (for example, two) recording layers 4 formed on one surface of the substrate 2. It is also possible to apply the present invention to an optical information medium where one or a plurality of recording layers 4 are formed on both surfaces. Here, such optical information media can realize the same effects as the optical information medium 1 described above.

In addition, although an example construction where the first sub-recording film 4a and the second sub-recording film 4b are adjoining in the thickness direction of the optical information medium 1 has been described above, it is also possible to interpose one or a plurality of extremely thin dielectric layers or the like between the first sub-recording film 4a and the second sub-recording film 4b, and it is also possible to interpose a layer of a mixture of the material that constructs the first sub-recording film 4a and the material that constructs the second sub-recording film 4b between the sub-recording films 4a and 4b. In addition, although an example where the present invention has been applied to an optical information medium 1 where the first sub-recording film 4a is formed on the light transmitting layer 6 side and the second sub-recording film 4b is formed on the substrate 2 side, the present invention is not limited to this and can be applied to an optical information medium where the second sub-recording film 4b is formed on the light transmitting layer 6 side and the first sub-recording film 4a is formed on the substrate 2 side.

Also, although an example construction equipped with the first dielectric layer 5a and the second dielectric layer 5b has been described, it is also possible to use a construction without one or both of the first dielectric layer 5a and the second dielectric layer 5b. In addition, it is possible to use a construction that is not equipped with the reflective layer 3. Also, although an example has been described above where a blue-violet laser beam L with a wavelength (λ) in a range of 380 nm to 450 nm, inclusive (as one example, 405 nm) is used during the recording and reproducing of data, it is possible to realize the same effects as described above when data is recorded and reproduced using various types of laser beams with wavelengths (λ) in a range of 250 nm to 900 nm, inclusive. In addition, the thicknesses of the various layers described above are mere examples to which the present invention is not limited, and such thicknesses can obviously be changed as appropriate.

What is claimed is:

1. An optical information medium comprising:
a substrate; and
a recording layer formed on the substrate, the recording layer including a first recording film formed of a first material that has Si as a main constituent and a second recording film that is formed of a second material that has Cu as a main constituent and to which Ni is added, the second recording film being formed in a periphery of the first recording film,
wherein data is recorded onto and reproduced from the recording layer by irradiation of the recording layer with a laser beam.

2. The optical information medium according to claim 1, wherein Ni is added in a range of at least 0.7 at % to less than 44.0 at % to the second material.

3. The optical information medium according to claim 1,
wherein the recording layer is constructed with the first recording film and the second recording film in contact.

4. The optical information medium according to claim 2,
wherein the recording layer is constructed with the first recording film and the second recording film in contact.

5. The optical information medium according to claim 1,
wherein a protective layer is formed on the recording layer.

6. The optical information medium according to claim 2,
wherein a protective layer is formed on the recording layer.

7. The optical information medium according to claim 3,
wherein a protective layer is formed on the recording layer.

8. The optical information medium according to claim 4,
wherein a protective layer is formed on the recording layer.

9. The optical information medium according to claim 5,
wherein the protective layer is formed so as to be capable of transmitting the laser beam,
the recording layer is constructed by forming the second recording film and the first recording film in the mentioned order on the substrate, and
data is recorded and reproduced by irradiation of the recording layer with the laser beam from the protective layer side.

10. The optical information medium according to claim 6,
wherein the protective layer is formed so as to be capable of transmitting the laser beam,
the recording layer is constructed by forming the second recording film and the first recording film in the mentioned order on the substrate, and
data is recorded and reproduced by irradiation of the recording layer with the laser beam from the protective layer side.

11. The optical information medium according to claim 7,
wherein the protective layer is formed so as to be capable of transmitting the laser beam,
the recording layer is constructed by forming the second recording film and the first recording film in the mentioned order on the substrate, and
data is recorded and reproduced by irradiation of the recording layer with the laser beam from the protective layer side.

12. The optical information medium according to claim 8,
wherein the protective layer is formed so as to be capable of transmitting the laser beam,
the recording layer is constructed by forming the second recording film and the first recording film in the mentioned order on the substrate, and
data is recorded and reproduced by irradiation of the recording layer with the laser beam from the protective layer side.

13. The optical information medium according to claim 9,
further comprising a first dielectric layer formed between the recording layer and the protective layer and a second dielectric layer formed between the substrate and the recording layer.

14. The optical information medium according to claim 10,
further comprising a first dielectric layer formed between the recording layer and the protective layer and a second dielectric layer formed between the substrate and the recording layer.

15. The optical information medium according to claim 11,
further comprising a first dielectric layer formed between the recording layer and the protective layer and a second dielectric layer formed between the substrate and the recording layer.

16. The optical information medium according to claim 12,
further comprising a first dielectric layer formed between the recording layer and the protective layer and a second dielectric layer formed between the substrate and the recording layer.

17. The optical information medium according to claim 13,
further comprising a reflective layer formed between the substrate and the second dielectric layer.

18. The optical information medium according to claim 14,
further comprising a reflective layer formed between the substrate and the second dielectric layer.

19. The optical information medium according to claim 15,
further comprising a reflective layer formed between the substrate and the second dielectric layer.

20. The optical information medium according to claim 16,
further comprising a reflective layer formed between the substrate and the second dielectric layer.
